(19) United States
(12) Patent Application Publication
(10) Pub. No.: US 2001/0055333 A1
(43) Pub. Date: Dec. 27, 2001

(54) Method and system for configuring an air interface in a modem

(76) Inventors: Aneesh Dalvi, Greely (CA); Amal Khailtash, Ottawa (CA)

Correspondence Address: BORDEN LADNER GERVAIS, LLP, 1000 - 60 QUEEN STREET, OTTAWA, ON, K1P 5Y7, CA

(21) Appl. No.: 09/811,566

(22) Filed: Mar. 20, 2001

(30) Foreign Application Priority Data
Mar. 20, 2000 (CA) 2,301,440

(51) Int. Cl. H04B 1/38; H04L 5/16

(52) U.S. Cl. 375/222

(57) ABSTRACT

A system and method for configuring an air interface processor in a modem. The air interface processor includes an event handler and a microsequencer. The event handler schedules data for transmission and reception in the modem. For transmission, the microsequencer sends commands to a frame formatter to format the data to be transmitted based on the schedule. Similarly for reception of data, microsequencer sends commands to a frame deformatter to deformat received data based on the schedule. The event handler, microsequencer, frame formatter and deformatter are programmable or configurable to accommodate different transmission formats and standards. A multi-way branching instruction is used in the programming of the microsequencer to enable faster processing.

### FIELD OF THE INVENTION

The present invention relates to a method and system for data transmission and reception in a modem. In particular, the present invention relates to a method and system for configuring an air interface for data transmission and reception in a modem according to multiple standards.

### BACKGROUND OF THE INVENTION

Generally, modems have been designed to work with one of many existing standards. For example, while there are many air interface, or radio link, standards, most current modems are designed to operate with only one of them. Even within a particular standard, uplink and downlink formats are very different, and require separately designed air interface processors. Clearly, this results in increased costs for both design and hardware when a new standard is implemented, and precludes using a modem designed to work with one standard from being reconfigured to work with a different standard.

An alternative approach to a hardware implementation is a software implementation in which the air interface and related modules are completely programmable. This is similar to the concept of a software radio. However, a serious disadvantage of the software approach is the slower throughput of the air interface since software solutions typically have much more overhead than hardwired solutions and run much slower. For example, it would not be unreasonable to expect a software implementation to run an order of magnitude slower compared to a hardware implementation.

It is therefore desirable to provide an air interface processor that can be configured for more than one standard, or data format while avoiding the undesirable constraints of a purely software implementation.

### SUMMARY OF THE INVENTION

It is an object of the present invention to provide a method and system that obviates or mitigates at least one disadvantage of the prior art. It is a particular object of the present invention to provide a method and system for configuring an air interface in a modem for multiple data and transmission standards and formats.

According to the invention, an air interface processor for a modem includes a programmable event handler, a programmable microsequencer and configurable data processing units such as a frame formatter. By data processing we refer generally to the processing of data including its examination, modification and manipulation. Data processing includes: the insertion of additional data bits to data and packaging the data in a specific format, for example, as performed in a typical frame formatter; discarding data bits and sorting data for queuing, for example, as performed in a frame deformatter; and other data related operations such as those performed in an FEC encoder or FEC decoder.

Accordingly, the modem and the air interface processor are programmable since the event handler and the microsequencer are programmable. They are also configurable since the data processing units (as well as the microsequencer and event handler as discussed below) are configurable. The modem and the air interface processor are also configurable in the sense that they can be configured to accommodate a standard or format by selecting which programs the event handler and microsequencer are to execute and loading the selected program into these devices along with any required setup operations.

In a first aspect, the present invention provides an air interface processor for a modem, comprising an event scheduling unit for scheduling the processing, by at least one data processing unit in the modem, of data to be transmitted by the modem; and a control unit for receiving instructions from the event scheduling unit and determining commands to send to the at least one data processing unit.

According to another aspect of the present invention, there is provided a method of processing data in a modem, comprising scheduling the processing of data for transmission by the modem; transmitting the schedule to a microsequencer; and sending commands to a frame formatter to build a frame of data in accordance with a program of the microsequencer.

According to a further aspect of the present invention, in a modem having configurable means for converting data into formatted data packages and programmable control means for controlling the configurable data conversion means, a method of controlling the conversion of data comprises configuring the configurable data conversion means in accordance with at least one communication standard; selecting one of the at least one communication standards; and programming the programmable control means in accordance with the selected communication standard to control the configurable data conversion means.

According to a still further aspect of the present invention, there is provided an air interface processor for a modem, comprising an event scheduling unit for scheduling the processing, by at least one data processing unit in the modem, of data received by the modem; and a control unit for receiving instructions from the event scheduling unit and determining commands to send to the at least one data processing unit.

According to a still further aspect of the present invention, there is provided method of processing data in a modem, comprising scheduling the processing of data reception by the modem; transmitting the schedule to a microsequencer; and sending commands to a frame deformatter to extract data from a frame of data in accordance with a program of the microsequencer.

According to a still further aspect of the present invention, in a modem having configurable means for extraction of data from formatted data packages and programmable control means for controlling the configurable data extraction means, a method of controlling the extraction of data comprises configuring the configurable data extraction means in accordance with at least one communication standard; selecting one of the at least one communication standards, and programming the programmable control means in accordance with the selected communication standard to control the configurable data extraction means

The present inventions, therefore has the advantage of allowing a modem to be programmable to accommodate different standards while operating significantly faster than a corresponding software implementation.

According to a still further aspect of the present invention, there is provided a method of programming a microsequencer to perform a multi-way branching instruction based on m sets of n conditions, the method comprising: establishing m lookup tables, each table having entries indexed by the n conditions of one of the m sets of n conditions, and each entry of each table having a lookup value; defining m functions, each function based on one of the m sets of n conditions; and determining, based on the m functions, the next program instruction to execute.

Advantageously, the multi-way branching instruction can be implemented in hardware to process the instruction much faster than a corresponding software implementation such as consecutive IF-THEN statements.

### BRIEF DESCRIPTION OF THE DRAWINGS

Additional details of present invention will now be described, by way of example only, with reference to the attached Figures, wherein:

FIG. 1 is a block diagram of a modem incorporating an air interface processor according to the present invention;

FIG. 2 is a block diagram of an air interface processor according to the present invention;

FIG. 3 is a chart of event handler instruction sets according to the present invention;

FIG. 4 is a chart of register access instructions according to the present invention;

FIG. 5 is a chart of data scheduling instructions according to the present invention;

FIG. 6 is a chart of burst descriptor instructions according to the present invention;

FIG. 7 is a chart of a modulator burst information field format according to the present invention;

FIG. 8 is a chart of a demodulator burst information field format according to the present invention;

FIG. 9 is a chart of a processor wait instruction according to the present invention;

FIG. 10 is a chart of a microsequencer instruction set according to the present invention;

FIG. 11 is a chart of a microsequencer memory format according to the present invention;

FIG. 12 is a block diagram of a configuration of condition codes and forks according to the present invention;

FIG. 13 is an example of fork values according to the present invention;

FIG. 14 is an example of three events to be transmitted by a device of the present invention;

FIG. 15 illustrates the events of FIG. 17 as stored in an event handler of the present invention;

FIG. 16 illustrates programs or sequences of instructions within a microsequencer of the present invention;

FIG. 17 is a terminal modulator block diagram in accordance with the present invention;

FIG. 18 is a block diagram illustrating the components of the forward error correction unit of FIG. 20;

FIG. 19 illustrates different headers stored in the frame formatter in accordance with the present invention;

FIG. 20 illustrates different characteristic polynomials accommodated by the Reed-Solomon encoder in accordance with the present invention;

FIG. 21 illustrates a formatted frame structure in accordance with the present invention;

FIG. 22 is a terminal demodulator block diagram in accordance with the present invention; and

FIG. 23 is a block diagram illustrating the components of the forward error correction decoder of FIG. 22.

### DETAILED DESCRIPTION OF THE INVENTION

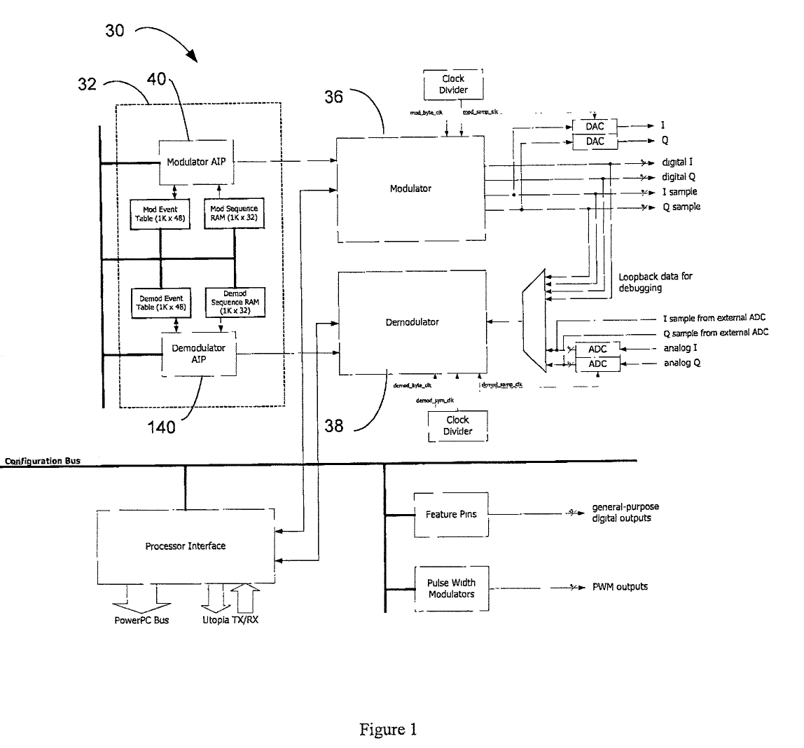

An embodiment of the present invention will now be described. FIG. 1 shows a modem 30 incorporating an air interface processor (AIP) 32 having a modulator air interface processor 40 and a demodulator air interface processor 140 which are associated with the modulator 36 and demodulator 38, respectively. Both the modulator 36 and the demodulator 38 have special-purpose processors that are designed with the intention of allowing the modem 30 to meet any air interface standard. However, it is impossible to predict whether all forthcoming LMDS and SatCom systems can be handled. For any systems which cannot be handled directly, there will be a provision to bypass internal FEC (forward error correction) generation/correction and process a raw bit stream.

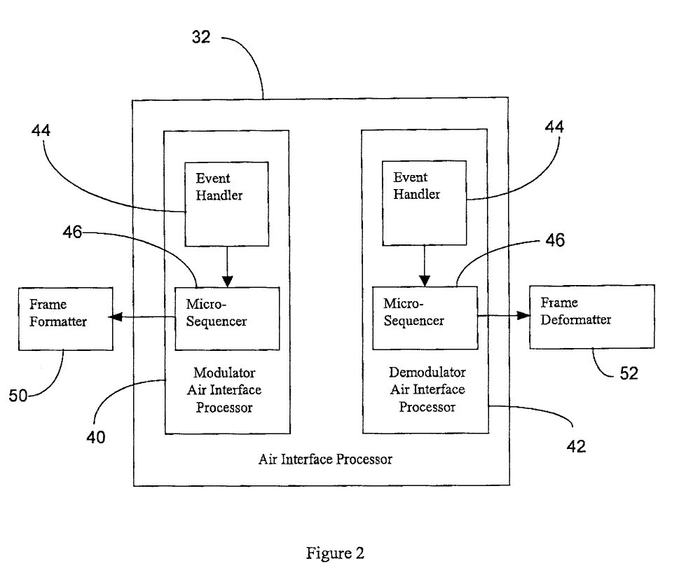

The air interface processor 32, is shown schematically in FIG. 2, and is divided into the modulator air interface processor 40 and the demodulator air interface processor 140. Each processor 40, 140 includes an event scheduling unit known as an event handler 44 and control means, for example, a control unit known as a microsequencer 46, 146. In FIG. 2, different microsequencers 46 and 146 are illustrated for the modulator air interface processor 40 and the demodulator air interface processor 140, respectively. Different microsequencers 46, 146 are preferred in the embodiment of FIG. 2 in order to accommodate different instruction sets associated with data transmission and receipt. However, it is fully contemplated that the same microsequencer can be used for both sides. For convenience, we will refer to the microsequencer 46 unless a distinction is needed.

The event handler 44 provides an abstraction of the burst frequency time plan; the microsequencer 46 controls how data is processed by the modulator/demodulator circuitry including means for the conversion of data into formatted data packages, such as frame formatter 50 and means for extracting data from formatted data packages, such as frame deformatter 150. According to the present example, the frame formatter 50 and the frame deformatter 150 are configurable, for example, to accommodate existing communication standards. Thus, for example, a frame formatter 50 can be instructed to format data in accordance with any one of a number of different standards. The algorithm used by the frame formatter 50 is predetermined, however, parameters used by the frame formatter, for example by way of register values, can be manipulated to configure the frame formatter to accommodate different standards and formats.

In the present embodiment, both the microsequencer 46 and the event handler 44 are hardware units programmable to accommodate different transmission standards and formats. Both the microsequencer 46 and the event handler 44 are also configurable, for example, by setting register values or setting the mode in which the device will operate (e.g. burst mode or continuous mode). In particular, the microsequencer 46 is configured by software at start up and configuration of the microsequencer 46 is intended to be static during the course of operation (though this is not a necessary condition). The event handler 44 configuration is static for continuous mode operation, and dynamic for burst mode to accommodate varying burst frequency time plans.

The primary purpose of the event handler 44 is to schedule the processing of burst data transmission/arrival in the modem 30. (Continuous data is treated as a special subset of burst data). In addition to being able to initiate sending/receiving bursts of data, the event handler 44 has the ability to perform various ALU operations, and to perform conditional or unconditional branches. The ALU and branch operations are performed simultaneously, which allows for greater code density than would otherwise be possible.

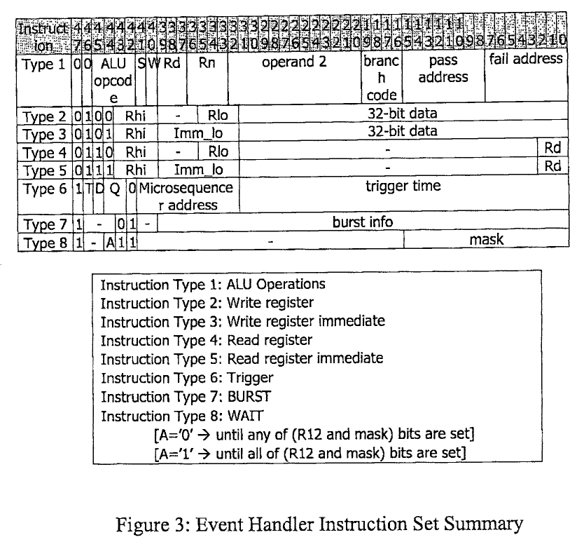

The instruction set is divided into general purpose and modem control instructions. There are 8 16-bit read/write registers, and 8 16-bit read-only registers. All instructions occupy one 48-bit word in memory. The instruction set summary is shown in FIG. 3. The event handler 44 memory is a single-port, synchronous, 1K * 48 RAM.

Type 1, general-purpose instructions (bits 47:46=00) are comprised of an ALU instruction and a two-way branch instruction. These ALU instructions are similar to standard ARM RISC processor ALU instructions. Note that the second operand always passes through a programmable barrel shifter before being applied to the ALU.

For each operation, the ALU computes a new result and the flags associated with that result (N=negative, Z=zero, C=carry, V=overflow). The results of the ALU operation are stored in the destination register only if the ‘W’ flag is asserted for that instruction. The ALU flags are updated only if the ‘S’ flag is asserted.

The results of the ALU operation are written to a destination register (Rd). The destination register may be any of the 8 read/write registers (R0-R7). Operand 1 (Rn) is always a register, and may be any of the 16 registers. Operand 2 is either an immediate value (I=1) or a register value (I=0), and is passed through a programmable barrel shifter to yield a 16-bit result.

In general, each ALU instruction performs the following operation:

| result = fn(Rn, shift(op2)) | |
|---|---|
| Rd | <= result if w else no change |
| {N,Z,C,V} | <= flags(result) if S else no change |

Standard ALU RISC and branch code operations are supported. The branch component of the instruction allows a conditional branch to happen based on the result of the previous ALU instruction. Each branch instruction has an address offset to jump to in the case the condition passes, and a separate address offset to jump to in the case the condition fails. This mechanism only allows for relative branches.

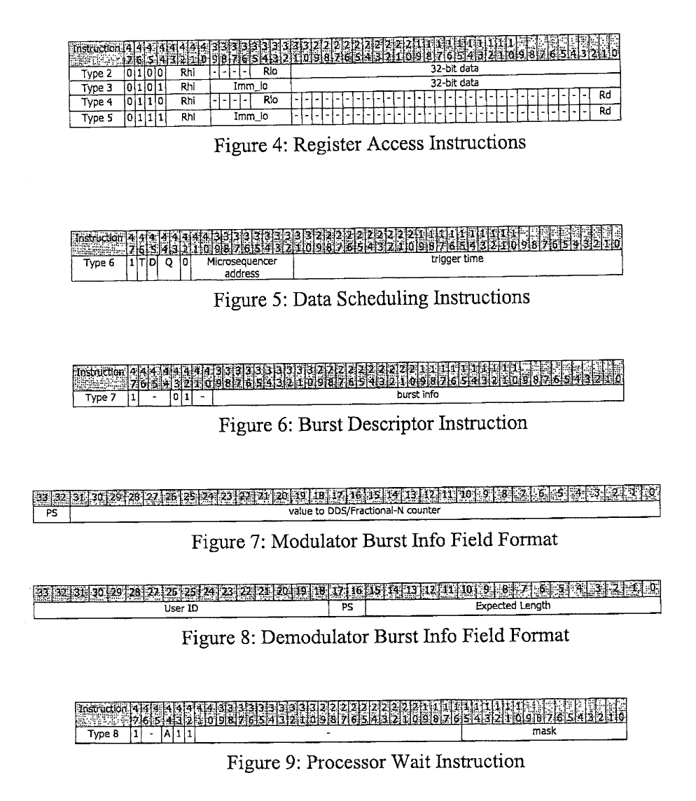

Register Access instructions (bits 47:46=01), as shown in FIG. 4, are provided to allow reading or writing arbitrary registers within the modem 30. The modulator air interface processor 40 can only control registers within the modulator 36, and the demodulator 38 air interface processor 42 can only control registers within the demodulator 38. This facility is used to enable/disable internal ASIC blocks, and to control external devices that need to be manipulated on a real-time basis, such as RF frequency select for MF-TDMA systems. It is not intended for static configuration, which is better handled via the processor interface (although it can be performed here as well).

Rhi provides the top 16 bits of the 24 bit address. R1o (bit 44=0) or imm_1o (bit 44=1) provides the bottom 8 bits. For a write operation (bit 45=0), the 32 bit data is contained directly in the lower bits of the instruction. For a read operation (bit 45=1), the bottom 3 bits encode the number of the destination register. The register access occurs over the internal HCPU bus.

Data scheduling instructions (bit 47=1), as shown in FIG. 5, are the means by which bursts of data are transmitted or received by the modem 30. Each of these instructions is an entry that maps time indices to actions. Time indices are specified in clock ticks relative to the start of a super-frame. Time index 0 is determined via the PCR algorithm (PCR offset). Actions are pointers to microcode instruction sequences. With this scheme, it is not necessary to count frames or even timeslots, only superframes.

For the execute phase of a data scheduling instruction, the event handler 44 will wait until the current time (time index relative to super-frame start) is approximately equal to the trigger time. (It can only wait for the times to be approximately equal because the event handler 44 runs off the byte clock, whereas the current time is a counter that runs off the sample clock.) When the trigger time is reached, a start command is sent to the microsequencer 46, which will begin running at the address specified in “microsequencer address”.

A time offset of 32′hFFFF_FFFF is a special code indicating that this event is to be processed immediately. The microsequencer address 0 is a special code indicating that the start command should not be sent.

If the trigger flag is set, the time offset in the current event is passed to the preamble insert module (not shown) in the modulator 36, or direct sampling module (not shown) in the demodulator 38.

Bursts can be conditional on the availability of data in a certain queue. In this case, the ‘D’ flag must be set to 1, and ‘Q’ must be set to the number of the data queue which must contain data (0→DATA1, 1→DATA2, etc).

For burst mode applications, the air interface processor 32 provides a special BURST instruction, as shown in FIG. 6, which is used to specify special information related to the following burst of data.

The contents of the burst info field are different for the modulator 36 and demodulator 38. For the modulator 36, as shown in FIG. 7, this field is used to select which preamble is to be used for the following burst (PS). Up to four preambles may be defined. For MF-TDMA applications, the burst info field contains frequency information that is used to reprogram the DDS or Fractional-N counter.

For the demodulator 38, as shown in FIG. 8, the burst info field is used to select the expected preamble for the incoming burst (PS). Up to four preambles may be defined. It also contains the length of the expected burst. The SB7016 tags all incoming bursts with an arbitrary user ID, which the MAC layer software can use to correlate received bursts with expected bursts in the BFTP. The user ID is specified in the burst info field.

FIG. 9 shows a typical processor wait instruction.

The microsequencer 46 is responsible for sending commands to the frame formatter 50/deformatter 52. On the modulator 36, this builds up a frame of data on a byte-by-byte basis.

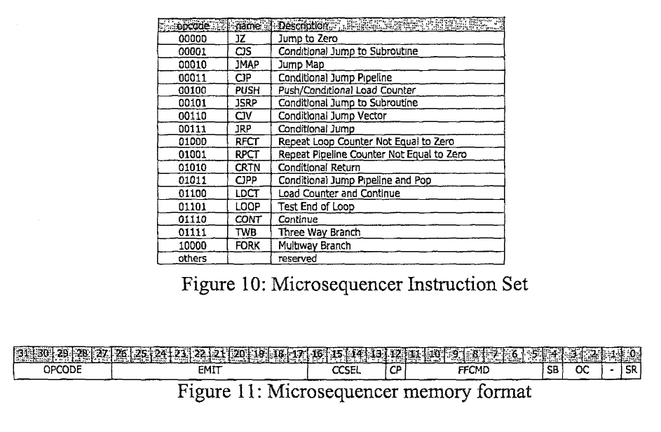

The core of the microsequencer 46 design is based on a modified version of the AMD2910 micro-program sequencer. The original 2910 is a 12 bit sequencer with a 32 word stack, and is capable of conditional branching, subroutine calls, and looping. The microsequencer 46 in the air interface processor 32 is a 10 bit sequencer, but adds some powerful instructions, as shown in FIG. 10, to perform multi-way conditional branching, among other things.

The number of microcode sequences is limited only by the available sequence RAM (SeqRAM) available. The SeqRAM is a single-port synchronous 1K * 32 RAM.

The microsequencer 46 has a program counter (PC), which is initially set by the event handler 44. When it is instructed to start by the event handler 44, it shall begin executing the instructions in SeqRAM at the specified address, until such time as a JZ (jump-to-zero) instruction is found.

The memory format for the modulator microsequencer 46 is shown in FIG. 11.

The EMIT field is used as an argument to the OPCODE field, and is used for branch addresses or to load the internal counter. The SR field (scrambler reset) can be used to reset the scrambler at any time.

The FORK instruction, which is an addition to basic 2910 instruction set, uses the value formed by the fork_cc(3:0) vector as the basis for a 16-way branch. For example, if the value of fork_cc is 12, the microsequencer 46 will advance its program counter by 12.

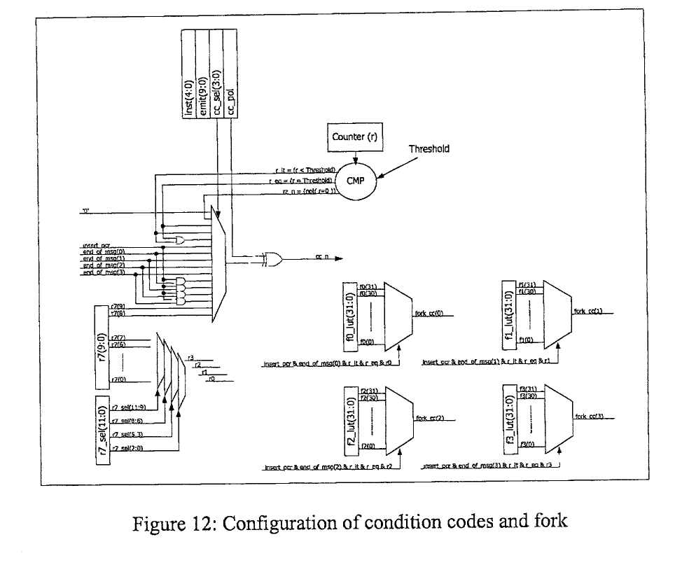

The fork_cc value is updated every clock cycle based on the configuration circuitry shown in FIG. 12. Each bit in fork_cc is derived from a programmable look-up table. A 5-bit value is used as the index to this look-up table.

TABLE 1
FORK LUT Indices

[chemical structure]

Programming the FORK instruction is a rather convoluted process, as it involves three layers of indirection. The FORK instruction is essentially a “case” statement. The idea is to generate a 4-bit value (fork_cc) to create an offset of 0 to 15. Each bit of fork_cc is derived from the corresponding FORK LUT. Each FORK LUT is indexed by the 5-bit number formed by the concatenation of the conditions shown in Table 1. The conditions r0, r1, r2, and r3 are bits from the R7 register in the event handler 44. The R7 bit select register can be used to select among the lower 8 bits of the R7 register. Refer to FIG. 12 for more details. The FORK instruction, as illustrated in FIG. 12, is implemented in hardware using memory means for the lookup tables and multiplexers to define corresponding functions fork_cc(0) to fork_cc(3). By memory means, we include any suitable storage means including hardware circuits such as read-only memory. This hardware implementation allows parallel decision making resulting in a much more efficient and faster solution than a corresponding software solution, for example, sequential conditional statements.

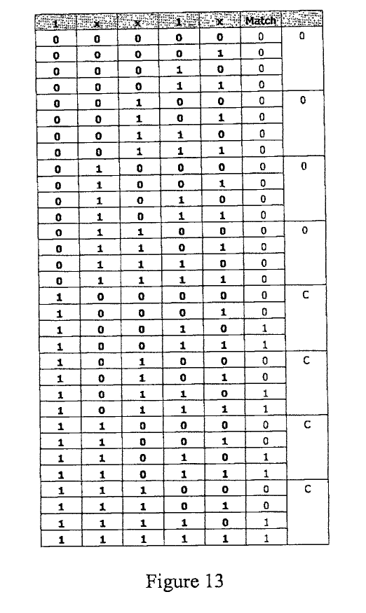

For example, suppose we wanted fork_cc(0) to evaluate as true whenever insert_pcr and counter═threshold are both true. This condition can be expressed as 1xx1x, which means that bits 4 and 1 must be 1, and the other bits are don't cares. In this case, we would program the bits in the LUT that match 1xx1x with 1, as shown in FIG. 13, and the others with 0. The value generated is 32′hCCCC_{—}0000.

In this example, fork_cc(0) is a boolean function of the 5 conditions of Table 1 and its values are defined by the lookup table of FIG. 13. For example, referring to the second row of 13, fork_cc(0)(0,0,0,0,1) is 0 as indicated by the lookup value in the “match” column. Of course, referring to Table 1, the arguments 0,0,0,0,1 represent the conditions: insert_per is false; end of message in queue 1 is false; counter<threshold is false; counter threshold is false; and r0 is true, respectively. Changing the lookup values in the lookup table of FIG. 13 will change the corresponding function fork_cc(0). In that sense, a function such as fork_cc(0) can be configured by setting the lookup values of the corresponding lookup table. Note that we use “function” to include the possibility that “don't care” relationships may exist, as illustrated in the example. The vector function fork_cc(3:0) is simply the vector equivalent of fork_cc(3) to fork_cc(0).

In the example of the present embodiment, it is desirable to have 16 way branching, based on a 5 bit index value. It is, of course, fully contemplated that multi-way branching is possible for fewer or more than 16-way branching and the invention is not confined to 5 bit index values (i.e. based on 5 conditions) and that other sizes of index values are possible.

The present example illustrates how the FORK instruction can be used to program a microsequencer. However, it is fully contemplated that the FORK instruction can be used in programming any suitable microprocessor.

The condition codes (CCSEL) for conditional branches (for example, CJV) in the microsequencer 46 are hard-coded as follows:

[chemical structure]

Register R7 in the modulator 36 event handler 44 can be used to control the microsequencer 46 to some degree. Bits 8 and 9 of the R7 register are used to generate condition codes 14 and 15. Bits 0 to 7 of the R7 register, in conjunction with the static R7 Bit Select register, can be used as inputs to the FORK LUT.

The read-only event handler 44 registers for the modulator 36 contain the following values:

[chemical structure]

The definition of FFCMD (frame formatter command) is shown in Table 2. This instruction set is used to generate frames to be fed into the modulator frame formatter 50. As data or control words are inserted, they can be flagged with an attribute indicating whether or not they should be scrambled, and which outer code is to be used (ie. Reed-Solomon, CRC, or neither). If the SB bit is asserted in the microsequencer 46 instruction, the scrambler is bypassed. The value in the OC field is used to select which outer coding scheme is to be used (0-3).

The frame formatter is also able to insert register values from the event handler 44 into the data stream. This mechanism allows the generated data stream to be more dynamic than would otherwise be possible. When the event handler 44 issues a start command to the microsequencer 46, the contents of R0 to R7 are passed through a programmable barrel shifter and stored as inputs to the frame formatter 50.

TABLE 2
Modulator Command Set for Frame Formatter

[chemical structure]

The most common use of the barrel shifter is to align an 8-bit value in one of the registers to the upper 8 bits of the 16-bit register value (inputs to the frame formatter 50 must be MSB-aligned). The barrel shifter is configured as follows:

[chemical structure]

Each Rx shift field is defined as follows.

[chemical structure]

A simple microcode sequence to generate an MPEG frame for a base station could be programmed in the following manner. This sequence indicates that all bytes except for the initial sync should be scrambled (“.S”) MPEG_FRAME:

| | | |
|---|---|---|
| CONT | CW1.OC1 | # 1 byte, typically 47h |
| CONT | CW2.S.OC1 | # 1 byte |
| CONT | CW3.S.OC1 | # 1 byte |
| CONT | CW4.S.OC1 | # 1 byte |

| | | | |
|---|---|---|---|
| LDCT | 182 | DATA2.S.OC1 | # send data from queue |

2, load counter

| | | | |
|---|---|---|---|
| loop: | RPCT loop | DATA2.S.OC1 | # continue pulling data |

from queue 2

# until counter reaches zero; total =

184

| | | |
|---|---|---|
| JZ | FLUSH | # indicates end of burst; soft |

reset

The device can act as a simple ATM segmentation engine by setting the control word to a 5-byte ATM header. Up to 16 simultaneous ATM connections can be handled in this manner (one per control word).

ATM_CONN_1:

| | | |
|---|---|---|
| CONT | CW1.S.OC1 | # CW1 = 5-bytes = { VPI/VCI=(a,b) |

}

| | | |
|---|---|---|
| LDCT 2 | NOP | # 4 NOPs because CW1 is 5 bytes |

| | | |
|---|---|---|
| loop1: | RPCT loop1 | NOP |

| | | |
|---|---|---|
| LDCT 46 | DATA1.S.OC1 | # send 48 bytes from queue 1 |

| | | |
|---|---|---|
| loop2: | RPCT loop2 | DATA1.S.OC1 |

| | |
|---|---|
| JZ | FLUSH |

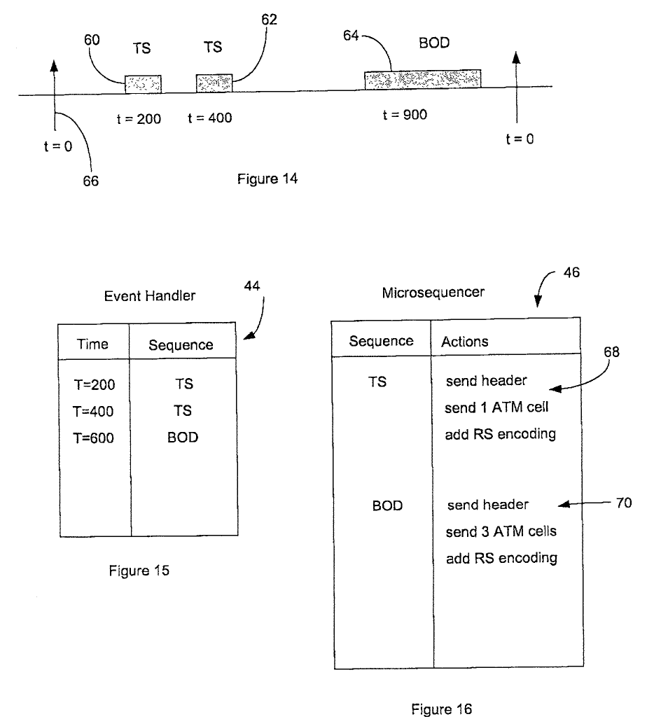

FIG. 14 illustrates a specific example illustrating the working of the event handler and microsequencer of the present invention. In the example there are three time slots 60, 62, 64 which have been assigned to a terminal by the system. The first and second time slots 60, 62 are normal time slots at times t=200 and t=400 respectively. The third time slot 64 is a bandwidth on demand time slot at time t=900. Time is relative to the beginning 66 of the super frame as indicated in FIG. 14 at t=0.

Three events corresponding to time slots 60, 62, 64 are stored in the event handler 44 as shown in FIG. 15. At or near the time of the first event, t=200, the event handler 44 sends a request to the microsequencer 46, to execute a sequence of instructions or program to handle a normal time slot.

Referring to FIG. 16, the microsequencer 46 contains programs directed at different time slot requirements and standards. For example, a first program 68, identified by the logical name TS in FIG. 16, is a program which will prepare a single ATM cell for transmission in a normal time slot. Note that FIG. 16 illustrates the steps of each program at the highest level of abstraction for the purposes of the present example. Of course, the specific commands in the program consist of instructions from the instruction set previously discussed.

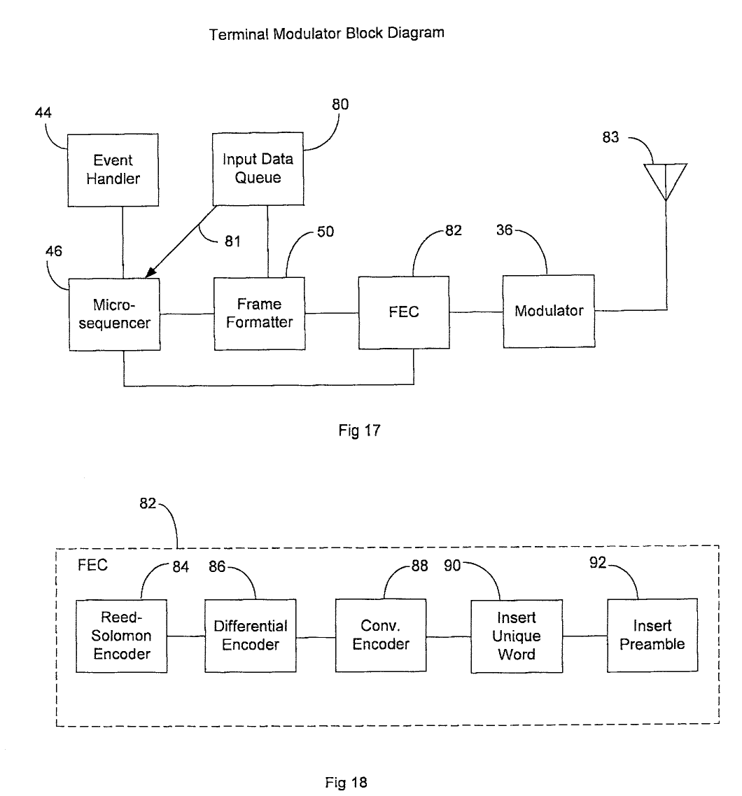

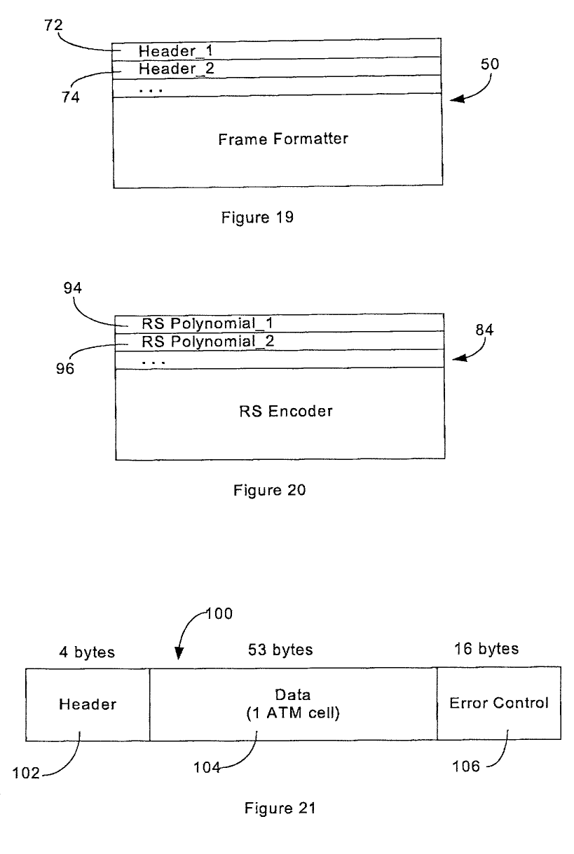

FIG. 17 is a schematic drawing illustrating the functional relationship between the event handler 44, the microsequencer 46 and the devices or modules which they control. Referring to FIGS. 16, 17 and 21, the first step of program TS 68 instructs the frame formatter 50 to use a 4 byte header 102 in accordance with a normal time slot. Referring to FIG. 19, different headers 72, 74 are stored as data within the frame formatter 50 itself. This facilitates the ability to configure the frame formatter 50 and to accommodate different transmission standards in accordance with the present invention. The specific 4 byte header 102 used by program TS 68 is Header_1 72 stored in the frame formatter 50. A plurality of headers can be stored in the configurable frame formatter 50 and the number of headers is only constrained by the size of the storage space available and the choices made in implementation of the invention.

The present invention is able to handle as input data either a raw data stream or formatted data such as ATM cells depending on how the device is programmed. In the present example, input data is packaged in 53 byte ATM cells and stored in the input data queue 80. The microsequencer 46 is kept informed of the status of the input data queue 80 as indicated by reference 81. The next step of program TS 68 is to instruct the frame formatter 50 to extract from the input data queue 80 a 53 byte ATM cell for transmission. The frame formatter 50 then appends this ATM cell to the Header_1 72 to form the header and data portions 102, 104 of the formatted frame structure 100.

The program then instructs the forward error correction unit 82 to perform the necessary operations. Referring to FIG. 18, forward error correction in the terminal modem includes Reed-Solomon encoding, differential encoding, convolutional encoding, insertion of unique word and preamble insertion as is known in the art. Program TS 68 instructs the Reed-Solomon (RS) encoder 84 to perform RS encoding according to a suitable characteristic polynomial, for example, RS (204, 188, 16) illustrated in FIG. 20 as polynomial_1 94. The RS encoder 84 is, however, configurable and it contains instructions in accordance with different characteristic polynomials 94, 96 to facilitate different configurations in accordance with the present invention.

Following RS encoding, the program instructs the differential encoder 86, convolutional encoder 88, and other modules 90, 92 to handle error correction coding. This results in an additional 16 byte error control block 106 appended after the header and data potions 102, 104 of the formatted frame structure 100 as illustrated in FIG. 21. Although not illustrated in the figures, a guard interval of one or more bytes may be appended to the end of the structure to prevent overlap between consecutively transmitted time slot structures.

Once program TS 68 of the microsequencer 46 has completed assembling the formatted frame structure 100, the structure 100 is passed onto the modulator 36 for transmission by antenna 83.

Returning to the event handler 44, once it has instructed the microsequencer 46 to handle the first event at time t=200, the event handler 44 remains idle until the next event at time t=400. At that time, the event handler 44 instructs the microsequencer 46 to handle the second event, which in the present example, requires another normal time slot. Accordingly, the event handler 44 instructs the microsequencer 46 to execute the program TS 68 which assembles a second one ATM cell data package with the next ATM cell in the input data queue 80 and passes the package onto the modem 36 for transmission.

The event handler 44 is active again at the time t=900 when event 3 requires a bandwidth on demand data transmission. Referring to FIG. 16, a second program, program BOD 70 in the microsequencer 46 is directed to preparing a data package having 3 ATM cells for transmission in a bandwidth on demand time slot.

Program BOD 70 begins by instructing the frame formatter 50 to use a header 102 in accordance with a bandwidth on demand time slot. This 4 byte header 102 has a structure similar to the header of a normal time slot and is represented as Header_2 74 in FIG. 19. Program BOD 70 then instructs the frame formatter 50 to fetch from the input data queue 80 three ATM cells which are appended to the Header_2 74.

Program BOD 70 then instructs the forward error correction unit 82 to perform coding and other operations needed to control errors. As in the case of program TS 68, an additional 16 bytes of data 106 are generated from this process and appended at the end of the formatted frame structure 100 for transmission by the modem 36 using antenna 110.

Of course, other frame formats not included in this example can be implemented as well. For example, another structure is the mini time slot structure which is used to transmit small amounts of data not bandwidth efficient for the normal time slot structure. Mini time slots are typically implemented within the duration of one normal traffic time slot and always occur at the end of a frame period. The type of data accommodated by mini time slots include information for management, signaling and ranging.

Mini time slots can be accommodated in the device of the previous example by programming the event handler 44 to recognize such events and including a program in the microsequencer 46 to build a suitable data structure, with corresponding changes in other modules such as the inclusion of a new header in the frame formatter 50.

Normal, mini and bandwidth on demand time slots are used by repetitive super frames in burst mode links. A characteristic of burst mode is that time slot size need not be constant and can vary depending on the type of time slot structure assigned by the system. Thus the event handler 44 is continuously modified by software in burst mode, depending on the burst frequency plan scheduled by the system.

An alternative approach supported by the present invention is continuous link mode in which a fixed frame structure is always repeated by the event handler 44. Thus, the header 102 always follows a single format, the data 104 remains a constant number of bytes and the size of the error control block 106 is fixed. In effect, continuous mode link is a special case of burst mode link and the device of the present invention can be programmed to operate in this fixed way.

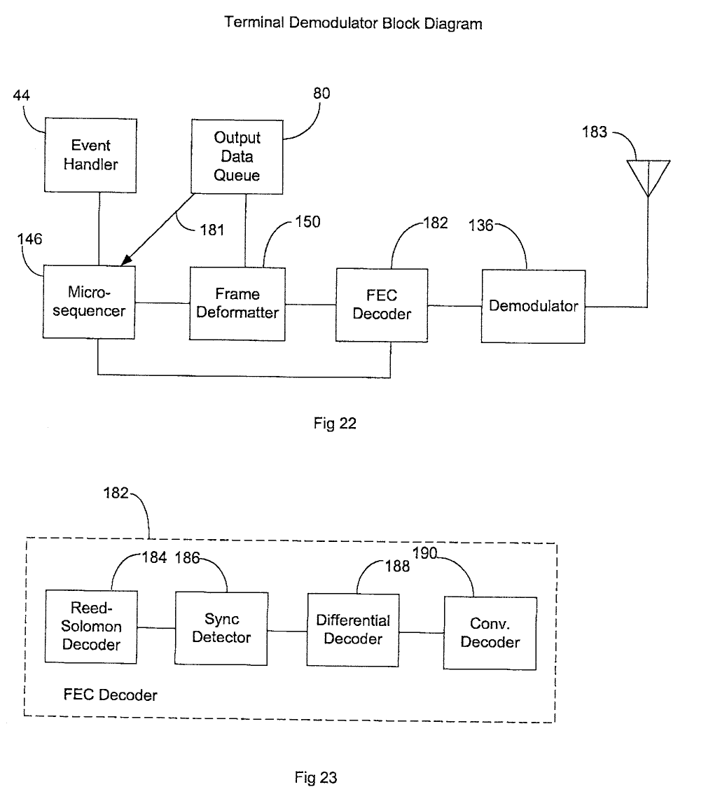

With reference to FIGS. 14 to 18, although the example described above has been in respect of the transmit side of a modem, the invention applies equally to the receive side. Referring to FIG. 22, details of a demodulator are illustrated. As noted earlier, a different microsequencer 146 can be used on the receive side.

Data received using antenna 183 is demodulated by demodulator 136. The data is then decoded by FEC decoder 182 and processed by frame deformatter 150 before going to output queue 180. The actions of these components are controlled by event handler 44 and microsequencer 146. The microsequencer 146 is kept informed of the status of the output data queue 180 as indicated by reference 181.

FIG. 23 provides details of FEC decoder 182. Specifically, FEC decoder 182 includes convolutional decoder 190 followed by differential decoder 188, sync detector 186 and Reed-Solomon decoder 184, as is well known in the art.

Furthermore, although the previous example has been with reference to a terminal modulator, the present invention is equally applicable to the base station. Specifically, the hardware FIGS. 2, 17 and 18 are the same for terminals and the base station, however, different modes are used. Similarly the present invention applies to the receive-side of the base station.

The above-described embodiments of the invention are intended to be examples of the present invention. Alterations, modifications and variations may be effected the particular embodiments by those of skill in the art, without departing from the scope of the invention which is defined solely by the claims appended hereto.

We claim:

1. An air interface processor for a modem, comprising:
an event scheduling unit for scheduling the processing, by at least one data processing unit in the modem, of data to be transmitted by the modem; and
a control unit for receiving instructions from the event scheduling unit and determining commands to send to the at least one data processing unit.

2. An air interface processor of claim 1 wherein the at least one data processing unit is a frame formatter.

3. An air interface processor of claim 2 wherein the at least one data processing unit further comprises a forward error correction unit.

4. An air interface processor of claim 1 wherein the control unit is a microsequencer.

5. An air interface processor of claim I wherein the event scheduling unit is programmable.

6. An air interface processor of claim I wherein the control unit is programmable.

7. An air interface processor of claim 2 wherein the frame formatter is configurable.

8. An air interface processor for a modem, comprising:
an event scheduling unit for scheduling the processing, by at least one data processing unit in the modem, of data received by the modem; and
a control unit for receiving instructions from the event scheduling unit and determining commands to send to the at least one data processing unit.

9. An air interface processor of claim 8 wherein the at least one data processing unit is a frame deformatter.

10. An air interface processor of claim 8 wherein the at least one data processing unit further comprises a forward error correction unit.

11. An air interface processor of claim 8 wherein the control unit is a microsequencer.

12. An air interface processor of claim 8 wherein the event scheduling unit is programmable.

13. An air interface processor of claim 8 wherein the control unit is programmable.

14. An air interface processor of claim 9 wherein the frame deformatter is configurable.

15. A method of processing data in a modem, comprising:
scheduling the processing of data for transmission by the modem;
transmitting the schedule to a microsequencer; and
sending commands to a frame formatter to build a frame of data in accordance with a program of the microsequencer.

16. A method of processing data in a modem, comprising:
scheduling the processing of data reception by the modem;
transmitting the schedule to a microsequencer; and
sending commands to a frame deformatter to extract data from a frame of data in accordance with a program of the microsequencer.

17. In a modem having configurable means for converting data into formatted data packages and programmable control means for controlling the configurable data conversion means, a method of controlling the conversion of data comprising:
configuring the configurable data conversion means in accordance with at least one communication standard;
selecting one of the at least one communication standards; and
programming the programmable control means in accordance with the selected communication standard to control the configurable data conversion means.

18. The method of claim 17 further comprising the step of using the programmed control means to determine a communication time schedule.

19. The method of claim 17 further comprising the step of using the programmed control means to control the configured data conversion means.

20. In a modem having configurable means for extraction of data from formatted data packages and programmable control means for controlling the configurable data extraction means, a method of controlling the extraction of data comprising:
configuring the configurable data extraction means in accordance with at least one communication standard;
selecting one of the at least one communication standards; and
programming the programmable control means in accordance with the selected communication standard to control the configurable data extraction means.

21. The method of claim 20 further comprising the step of using the programmed control means to determine a communication time schedule.

22. The method of claim 20 further comprising the step of using the programmed control means to control the configured data extraction means.

23. A method of programming a microsequencer to perform a multi-way branching instruction comprising:
(a) establishing a lookup table having entries indexed by n conditions and each entry having a lookup value;
(b) defining a function of the n conditions based on the lookup table; and
(c) determining, based on the function, the next program instruction to execute.

24. The method of claim 23, wherein step (c) comprises the step of determining, based on the function, an offset for determining the next program instruction to execute.

25. The method of claim 24, wherein step (b) comprises defining a boolean function of the n conditions based on the lookup table.

26. A method of programming a microsequencer to perform a multi-way branching instruction based on m sets of n conditions, the method comprising:
(a) establishing m lookup tables, each table having entries indexed by the n conditions of one of the m sets of n conditions, and each entry of each table having a lookup value;
(b) defining m functions, each function based on one of the m lookup tables; and
(c) determining, based on the m functions, the next program instruction to execute.

27. The method of claim 26 wherein step (b) comprises the step of defining m boolean functions, each boolean function based on one of the m lookup tables.

28. The method of claim 27, wherein step (c) comprises the step of interpreting the m boolean functions as a binary value to determine an offset for determining the next program instruction to execute.

29. The method of claim 26, wherein at least one of the m functions can be configured by setting the lookup values of the entries in the corresponding lookup table.

30. An apparatus for performing a multi-way branching instruction by a microsequencer based on m sets of n conditions, the apparatus comprising:
memory means storing m lookup tables, each table having entries indexed by the n conditions of one of the m sets of n conditions, and each entry of each table having a lookup value;
hardware means defining m functions, each function based on one of the m lookup tables; and
software means for determining, based on the m function, the next program instruction to execute.

31. The apparatus of claim 30, wherein at least one of the m functions can be configured by setting the lookup values of each entry of the corresponding lookup table.

32. The apparatus of claim 30, wherein the hardware means comprises m multiplexers.

33. A method of programming a microprocessor to perform a multi-way branching instruction based on m sets of n conditions, the method comprising:
(a) establishing m lookup tables, each table having entries indexed by the n conditions of one of the m sets of n conditions, and each entry of each table having a lookup value;
(b) defining m functions, each function based on one of the m lookup tables; and
(c) determining, based on the m functions, the next program instruction to execute.

34. An modem comprising:
a modulator; and
an air interface processor for the modulator,
the air interface processor having an event scheduling unit for scheduling the processing, by at least one data processing unit in the modem, of data to be transmitted by the modem and a control unit for receiving instructions from the event scheduling unit and determining commands to send to the at least one data processing unit.

35. An modem comprising:
a demodulator; and
an air interface processor for the demodulator,
the air interface processor having an event scheduling unit for scheduling the processing, by at least one data processing unit in the modem, of data received by the modem and a control unit for receiving instructions from the event scheduling unit and determining commands to send to the at least one data processing unit.
